(19) United States
(12) Patent Application Publication
(10) Pub. No.: US 2005/0118482 A1
(43) Pub. Date: Jun. 2, 2005

(54) Electrochemical devices and components thereof

(75) Inventors: Suresh Sriramulu, Arlington, MA (US); Anant Singh, Burlington, MA (US); Johannes H. Thijssen, Redmond, WA (US); Eric Carlson, Sudbury, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: TIAX LLC, Cambridge, MA (US)

(21) Appl. No.: 10/944,273

(22) Filed: Sep. 17, 2004

Related U.S. Application Data
(60) Provisional application No. 60/504,285, filed on Sep. 17, 2003.

(51) Int. Cl. H01M 8/24; B05D 5/12

(52) U.S. Cl. 429/34; 427/115; 429/13

(57) ABSTRACT

An interconnect utilizing a metal matrix composite of at least one metal selected from the group consisting of copper, oxide dispersion strengthened copper, aluminum, titanium, and alloys thereof, and at least one reinforcing material selected from the group consisting of carbon, boron carbide, silicon carbide, zirconium carbide, hafnium carbide, tantalum carbide, titanium carbide, zirconium diboride, hafnium diboride, tantalum diboride, titanium diboride, silicon dioxide, aluminum oxide, alumino-silicate, silicon nitride, and aluminum nitride is disclosed. The interconnect can be utilized as a component of an electrochemical device. The interconnect can have a coefficient of thermal expansion that is within about 10% of a coefficient of thermal expansion of a component or assembly of the electrochemical device.

### RELATED APPLICATIONS

This application claims priority under 35 U.S.C. § 119(e) to U.S. Provisional application Ser. No. 60/504,285, entitled “USE OF CONDUCTIVE COMPOSITE MATERIALS IN HIGH TEMPERATURE ELECTROCHEMICAL DEVICES,” filed on Sep. 17, 2003, which is herein incorporated by reference in its entirety.

### FEDERALLY SPONSORED RESEARCH

This invention was made with Government support under U.S. Department of Commerce Award No. 70NANB3H3018. The Government may have certain rights to this invention.

### BACKGROUND OF THE INVENTION

1. Field of Invention

The present invention relates to electrochemical devices, and more particularly, to electrochemical devices such as fuel cells having interconnect components comprising metal matrix composites.

2. Discussion of Related Art

Electrochemical devices such as fuel cells can convert chemical energy into electrical energy. Conversion involves controlled oxidation of a fuel such as hydrogen, a hydrocarbon, or reformed hydrocarbon. Fuel cell assemblies can include one or, preferably, a plurality of stacked cells. A fuel cell has an anode and a cathode separated by an electrolyte. The fuel cell can also comprise one or more interconnects. The electrodes and electrolyte can be arranged as an assembly. Such assemblies are referred to as the Electrodes-Electrolyte Assembly (EEA), typically in solid oxide fuel cells, Positive electrode Electrolyte Negative electrode (PEN), and Membrane Electrode Assembly (MEA).

Notably, efforts undertaken to develop materials for components of such electrochemical devices, interconnects in particular, have taken divergent approaches. One approach relies on interconnects comprising ceramic materials; while another approach relies on interconnects comprising metallic materials. Some effort has been undertaken to utilize metal matrix composite materials.

Yoshimura et al., in U.S. Pat. No. 5,279,906, disclose an interconnection material for solid oxide fuel cells. The interconnection material is made of a mixture of an alloy, mainly containing nickel and chromium, with oxide ceramics in an amount of 50 to 85 wt % of the mixture.

Minh et al., in U.S. Pat. No. 5,356,730, disclose a monolithic fuel cell. The interconnect layer composition includes (i) a mixture of an electrical conductor and a ceramic matrix material that is sinterable in an oxidizing atmosphere at a temperature of less than about 1500° C., (ii) a mixture of a lanthanum chromite-based ceramic and a yttrium chromite-based ceramic, or (iii) a yttrium chromite-based ceramic of the form Y_{w-x-y}CaₓZr_{y}Cr_{v-z}Zn_{z}O₃, where w is from about 0.9 to about 1.1, x is from about 0.1 to about 0.3, y is from about 0.001 to about 0.1, z is from about 0.1 to about 0.3, and v is from about 1 to about 1.2.

Lessing, in U.S. Pat. No. 5,496,655, discloses a catalytic bipolar interconnection plate for use in a fuel cell. The plate is manufactured from an intermetallic composition, examples of which include NiAl or Ni₃Al with a ceramic filler.

Fasano et al., in U.S. Pat. No. 6,051,330, disclose a solid oxide fuel cell having vias and a composite interconnect. The interconnect is made from a cermet including partially stabilized tetragonal zirconia and a superalloy that is resistant to oxidizing and reducing conditions.

The related art, however, has failed to realize the advantages and features of the devices and techniques, and components thereof, of the present invention.

### SUMMARY OF THE INVENTION

In accordance with one or more embodiments, the invention relates to an electrochemical device. The device comprises an electrodes-electrolyte assembly and an interconnect in communication with the electrodes-electrolyte assembly. The interconnect comprises a metal matrix composite of at least one metal selected from the group consisting of copper, oxide dispersion strengthened copper, aluminum, titanium, and alloys thereof, and at least one reinforcing material selected from the group consisting of carbon, boron carbide, silicon carbide, zirconium carbide, hafnium carbide, tantalum carbide, titanium carbide, zirconium diboride, hafnium diboride, tantalum diboride, titanium diboride, silicon dioxide, aluminum oxide, alumino-silicate, silicon nitride, aluminum nitride, and mixtures thereof.

In accordance with one or more embodiments, the invention relates to an electrochemical device. The electrochemical device comprises a metal matrix composite and an electrodes-electrolyte assembly in communication with the metal matrix composite. The metal matrix composite having a coefficient of thermal expansion of about 6×10⁻⁶ to about 14×10⁻⁶/° C. and within about 10% of a coefficient of thermal expansion of the electrodes-electrolyte assembly.

In accordance with one or more embodiments, the invention relates to a method of generating electrical energy. The method comprises an act of providing fuel and oxidizer to a fuel cell comprising a metal matrix composite of at least one metal selected from the group consisting of copper, oxide dispersion strengthened copper, aluminum, titanium, and alloys thereof, and at least one reinforcing material selected from the group consisting of carbon, boron carbide, silicon carbide, zirconium carbide, hafnium carbide, tantalum carbide, titanium carbide, zirconium diboride, hafnium diboride, tantalum diboride, titanium diboride, silicon dioxide, aluminum oxide, alumino-silicate, silicon nitride, aluminum nitride, and mixtures thereof.

In accordance with one or more embodiments, the invention relates to a method of facilitating electrical power generation. The method comprises an act of providing a fuel cell comprising an electrodes-electrolyte assembly and an interconnect disposed in contact with a surface of the electrodes-electrolyte assembly, the interconnect comprising a metal matrix composite of a copper or copper alloy and a ceramic selected from the group consisting of silicon carbide, boron carbide, and aluminum oxide.

In accordance with one or more embodiments, the invention relates to a method of fabricating a fuel cell. The method comprises acts of providing an electrodes-electrolyte assembly and providing an interconnect comprising a metal matrix composite having a coefficient of thermal expansion that is within about 10% of a coefficient of thermal expansion of the electrodes-electrolyte assembly.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic representation of a stack including a plurality of electrochemical devices having components in accordance with one or more embodiments of the invention;

FIGS. 2A-2C are graphs depicting the coefficient of thermal expansion (CTE) with respect to particle or reinforcement volume fraction for Cu/SiC composites (FIG. 2A), Cu/B₄C composites (FIG. 2B), and Cu/Al₂O₃ composites (FIG. 2C) of the invention, along with measured CTE values of prepared specimens during heating “▴” and cooling “●”;

FIG. 3 shows copies of micrographs for Cu/SiC composite specimens of the invention having about 40% (bottom row), about 47.5% (middle row), and about 55% by volume (top row) with SiC particle size in a range of about 10 to about 20 μm (left column) and in a range of about 40 to about 60 μm (right column);

FIG. 4 shows copies of micrographs of a Cu/SiC composite (top), a Cu/Al₂O₃ composite (middle), and a Cu/B₄C composite (bottom) of the invention;

FIG. 5 is a graph showing measured CTE (about 200 to about 800° C.) of forged Cu/SiC composites of the invention relative the theoretical CTE values;

FIG. 6 is a schematic diagram of an SOFC simulated to analyze the influence of material thermal conductivity on system performance; and

FIG. 7 is a graph showing simulation results predicting power density as a function of the thermal conductivity of an interconnect of the invention.

### DETAILED DESCRIPTION OF THE INVENTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

In accordance with one or more embodiments, the invention relates to electrochemical devices or a stack or assembly of electrochemical devices. The electrochemical devices of the invention can be a fuel cell that can convert, typically directly, chemical energy into electrical energy. The fuel cell can be a molten carbonate fuel cell (typically referred to as MCFC), a solid oxide fuel cell (typically referred to as SOFC), or one that utilizes proton-conducting ceramic electrolytes. The electrochemical device can also be an electrolysis device or an electrochemical gas separation device. The electrochemical devices of the invention typically operate at a temperature range of between about 200° C. to about 900° C.

In accordance one or more embodiments, the invention relates to a method of generating electrical energy utilizing one or more of the electrochemical devices of the invention. The method can comprise providing a fuel and an oxidizer to one or more electrochemical devices, at least one of the electrochemical devices preferably comprises a metal matrix composite.

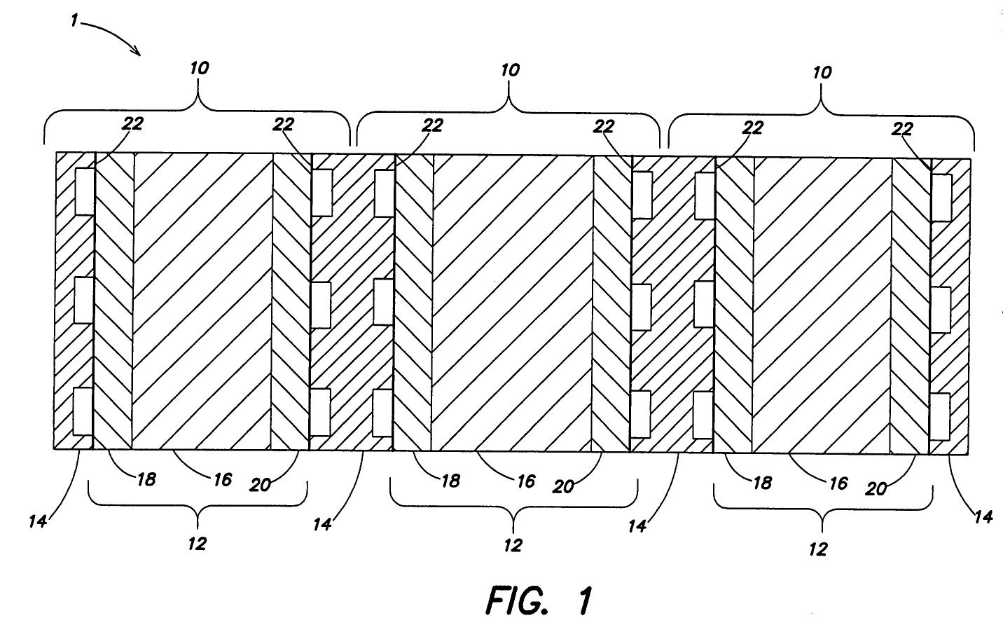

In accordance with some embodiments of the invention and as exemplarily shown in FIG. 1, a bipolar planar stack 1 can comprise a plurality of electrochemical devices or fuel cells 10. One or more fuel cell 10 of stack 1 can comprise an electrodes-electrolyte assembly (EEA) 12 and an interconnect 14 typically in communication with EEA 12, electrically, thermal, and/or structurally. EEA 12 typically comprises an electrolyte 16 disposed to be in electrical and ionic communication with an anode 18 and a cathode 20.

Interconnect 14 typically includes features such as channels 22 that facilitate or direct the fuel or oxidizer for reaction in EEA 12. Interconnect 14 can also serve as a current collector during operation of electrochemical device 10 to provide or direct generated electrical energy to a load (not shown). In some cases, interconnect 14 can have a coating (not shown), disposed on a surface adjacent to an interface 22 with EEA 12. A sublayer or interlayer (not shown) can also be utilized between the coating and a surface of the interconnect.

The interconnect is typically thermo-mechanically stable throughout its service life, e.g., at least about 5,000 hours, in some cases at least about 40,000, in other cases at least about 80,000 hours, relative to its configuration at room temperature or at initial startup or when initially placed in service. The interconnect can also be chemically stable and at least partially resistant to corrosion in its operating environment. The interconnect can comprise any material or mixtures or alloys of materials, preferably a non-intermetallic material, that renders the interconnect electrically, thermally conductive, and/or impermeable to the chemical reactants and/or products, such as the fuel, the oxidizer and water, of the electrochemical device, while providing acceptable, preferably negligible, creep. Typically, the interconnect comprises a material, mixture of materials, alloys, and/or composites that provides a coefficient of thermal expansion (CTE) that is about the same as or at least about 70%, in some cases at least about 80%, in other cases at least about 90%, and in still other cases at least about 97.5% of any of the components or assemblies of the electrochemical device throughout, or at least partially throughout the service conditions thereof. Alternatively, the interconnect can have a CTE that is within about 20%, typically within about 10%, preferably within about 10%, more preferably within about 2.5%, of a CTE of a component or assembly of the electrochemical device. In accordance with one or more preferred embodiments, the interconnect can comprise one or more materials having an electrically resistivity of less than about 30 milliohm-cm, in some cases, less than about 20 milliohm-cm, in other cases less than about 10 milliohm-cm, and in still other cases less than about 5 milliohm-cm in a temperature range of about 0° C., or even about −40° C., to about 900° C., and typically in a temperature range between about 200° C. to about 900° C. In accordance with still other embodiments, the interconnect can comprise one or more materials having a density less than steel, nickel alloy and/or superalloys. The interconnect can also comprise a material that having a high thermal conductivity that reduces the likelihood or magnitude of any thermal gradient within the electrochemical device or components thereof. For example, the interconnect can have a thermal conductivity of at least about 50 W/m·K, in some cases at least about 100 W/m·K, in other cases at least about 125 W/m·K, in other cases at least about 150 W/m·K, preferably at least about 200 W/m·K, more preferably at least about 220 W/m·K.

The material composition of the interconnect can be selected to match or to have a CTE profile, with respect to, for example, temperature, that matches, e.g. is within an acceptable or predetermined variation or tolerance, a CTE profile of a component or assembly of the electrochemical device. The material composition can also be selected to reduce any associated displacement between an adjacent component so that any relative movement can be likewise reduced, or even eliminated, which in turn can reduce any damage associated with or as a consequence of relative motion. Thus, the material composition of the interconnect can be selected to reduce, or even eliminate any stress, and any associated deformation strain, between components in an electrochemical device during operation and/or cycling thereof.

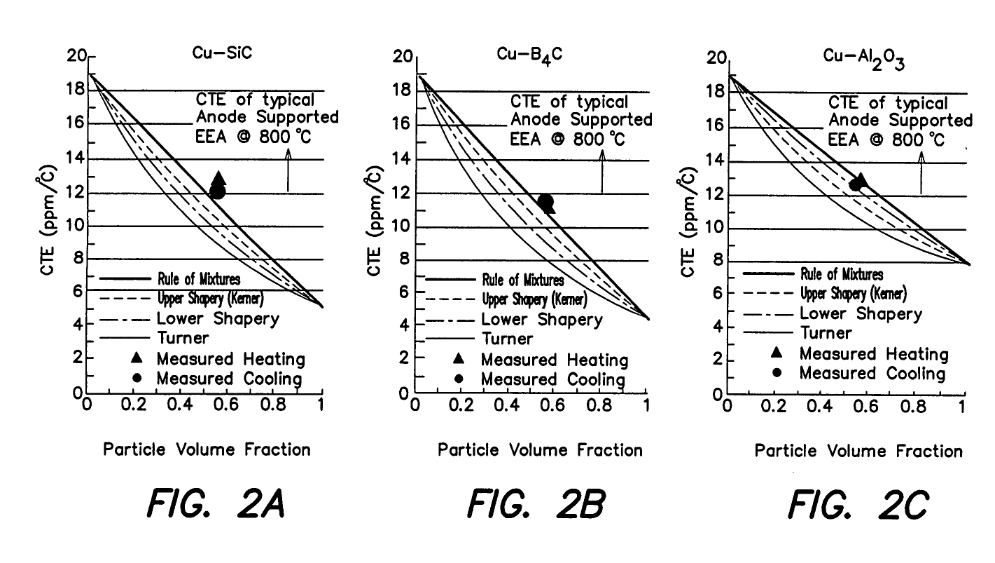

Selection of materials of the interconnect can be performed by identifying a target CTE and formulating by specifying the relative amounts of components of the interconnect material. Predicting the CTE of the composite material of the invention can be performed by utilizing any suitable model including, for example, models based on the rule of mixtures and those forwarded by Schapery, Kerner, and Turner. (See, for example, R. A. Schapery, “Thermal expansion coefficients of composite materials based on energy principles,” Journal of Composite Materials, 2, 380-404 (1968).) The rule of mixtures model relies on the assumption that the two phases essentially do not interact. The Turner's model assumes that the two phases can experience the same local volumetric strain. The lower Schapery and upper Schapery (Kerner) models are based on elastic energy principles. It is believed that the Kerner model will capture the composite behavior when isolated particles are surrounded by a contiguous matrix when both phases deform elastically. The composition of a material of the invention can be derived utilizing any of these models to achieve a composite material with a target or desired CTE. For example, with reference to FIGS. 2A-2C, the composition of a Cu/SiC composite of the invention with a target CTE of about 14×10⁻⁶/° C. would be in a range of about 65% to about 80% by volume copper and in a range of about 20% to about 35% by volume silicon carbide (from FIG. 2A); likewise, a Cu/B₄C composite of the invention would be in a range of about 65% to about 80% by volume copper and in a range of about 20% to about 35% by volume boron carbide (from FIG. 2B), and a Cu/Al₂O₃ composite of the invention would be in a range of about 55% to about 75% by volume copper and in a range of about 25% to about 45% by volume aluminum oxide (from FIG. 2C).

The interconnect can comprise a metal matrix composite, having at least one continuous phase, typically a metal, and a reinforcement phase, typically a ceramic or a metal. The reinforcing phase can be continuous or discontinuous. The metal can be selected from the group consisting of copper, aluminum, titanium, and alloys thereof. In some cases, the metal can be a strengthened metal such as, but not limited to, oxide dispersion strengthened copper. The reinforcing phase can be selected from the group consisting of carbon, boron carbide, silicon carbide, zirconium carbide, hafnium carbide, tantalum carbide, titanium carbide, zirconium diboride, hafnium diboride, tantalum diboride, titanium diboride, silicon dioxide, aluminum oxide, alumino-silicate, silicon nitride, aluminum nitride, and mixtures thereof. In some cases, the interconnect material can be characterized as a metal/ceramic composite, distinguishable from a ceramic having electrically conductive inclusions or vias, typically comprising a metal because, in the latter, the conductive inclusions serve no thermo-mechanical function. The metal/ceramic composite of the invention can also be distinguished from a metallic interconnect having a ceramic protective coating because no compositional correspondence is performed to achieve target physical properties, e.g. electrical, chemical, thermal, and/or mechanical, for the bulk substrate.

In accordance with further embodiments of the invention, the material of composition can vary with respect to its geometrical configuration. For example, the amount of reinforcing ceramic materials dispersed in the metal or metal alloy continuous phase can vary as a function of the distance from the interconnect surface. Thus, the interconnect can have an increasing, or even decreasing, ceramic component density, in the metal matrix composite, toward the center of the interconnect. Likewise, the interconnect can have a varying ceramic component density with respect to distance from its outer edges to its core. For example, the interconnect can have higher ceramic component relative to regions toward the interconnect center. The variation can be continuous providing a gradual change in, for example, ceramic component contribution, or it can be discrete providing step-wise or incremental changes.

In accordance with further embodiments of the invention, the interconnect can utilize a first metal, a second metal, and an alloy thereof. For example, the interconnect can substantially have the first metal in a first region, such as along its outer edges, and can have the second metal in second region, such as at its center, and an alloy of the first and second metal in the region between the first and second regions.

In accordance with still further embodiments of the invention, the interconnect can comprise a plurality of types of ceramic components, one or more types of ceramic components having a plurality of geometrical configurations, a plurality of metallic components, or combinations thereof. Thus, for example, the interconnect can have a first metal or metal alloy with a first ceramic component at, along or in the regions of its outer edges and a second metal or metal alloy with a second ceramic component about its core or central region. Likewise, the interconnect can have a first ceramic component at, along or near its outer edges and a second ceramic component in the central region, with a common metal or metal alloy.

In accordance with some embodiments, the metal matrix composite of the invention can comprise from about 20% to about 80% by volume copper or a copper alloy and from about 20% to about 80% by volume silicon carbide, in some cases from about 40% to about 60% by volume copper and from about 40% to about 60% by volume silicon carbide, and in other cases, about 45% by volume copper and about 55% by volume silicon carbide. In accordance with other embodiments, the metal matrix composite of the invention can comprise from about 20% to about 80% by volume of copper or copper alloy and from about 20% to about 80% by volume boron carbide, and in some cases about 45% by volume copper and about 55% by volume boron carbide. In accordance with still further embodiments, the metal matrix composite of the invention can comprise from about 20% to about 80% by volume copper or copper alloy and from about 20% to about 80% by volume aluminum oxide.

In accordance with one or more preferred embodiments of the invention, the interconnect comprises from about 30% to about 80% by volume copper/from about 20% to about 70% by volume silicon carbide, boron carbide, or alumina. The copper can be substantially pure copper, oxide dispersion strengthened copper, oxygen free high conductivity copper or alloys of copper such as, but not limited to, Cu—Ni, Cu—Si, and Cu—Fe alloys. The reinforcing materials, such as silicon carbide, boron carbide, and/or alumina, can be present as particles, aggregates, agglomerates, continuous and/or discontinuous fibers, macromolecular structures, nanotube, or combinations thereof. Further, reinforcing materials can have any suitable or desired sized. For example the particles can have a largest dimension of less than about 1 μm, or even less than about 10 μm, in some cases, about 15 μm, in other cases the particles can have a dimension between about 40 to about 60 μm, and in yet other cases about 100 μm. Further, the particles can have a varied size distribution such that, for example, the particle size distribution can be poly-modal, e.g., bimodal, trimodal, or higher-modal, wherein the statistical distribution of particle sizes can be characterized by distinct peaks.

The invention is directed to materials that have high thermal conductivity while having a coefficient of thermal expansion that is matched, to have a difference that is within an acceptable tolerance, with a component or assembly of an electrochemical device, e.g. the EEA of an SOFC. Thus, for example, the materials of the invention can be utilized as an interconnect having a CTE that is in a range of about 9.5×10−6/° C. to about 12.5×10−6/° C. to match the CTE of an EEA. In some cases, the materials can also have high electrical conductivity compared to conventional materials of composition utilized in fuel cells. As shown in Table 1, exemplary metal matrix composites (Cu/SiC with differing compositions) of the present invention have excellent thermal conductivity. Thus, for example, the CTE of a Cu/SiC composite can be matched to be within the desired range by selecting the amount of copper and amount of silicon carbide accordingly.

TABLE 1
Overview of Material Properties of Typical Interconnect Materials
and Expected Range of Physical Properties (E—excellent,
M—moderate, P—poor).

| | | Electrical | Thermal |
|---|---|---|---|
| | CTE | Resistivity | Conductivity |
| Material | ×10⁻⁶/° C. | μohm-cm | W/m · K |
| La_{0.8}Ca_{0.2}CrO₃ | E | M | P |
| La_{0.7}Sr_{0.3}CrO₃ | 9.5-10.5 | 40-60 | 2-4 |
| Ni Superalloys | P | E | M |
| | 14-19 | 100-130 | 17-30 |
| Ferritic Steels | M | E | M |
| | 11.5-14.5 | 60-120 | 20-40 |
| High Cr ODS alloys | E | E | M |
| | 11-12.5 | ˜30 | ˜40 |
| Cu/SiC composite | E | E | E |
| (expected range for | 9-15 | 5.3-2.3 | 100-220 |
| 30-60 vol % Cu) | | | |

The metal matrix composite can be prepared by any known technique that can provide a material matrix with one or more continuous phases and one or more discontinuous phases. The continuous phase typically comprises one or more metals or metal alloys. The discontinuous phase typically comprises one or more reinforcing materials, such as one or more ceramics. For example, the metal matrix composite can be prepared by solid-state processes, powder metallurgy techniques such as forging or liquid-state processes such as infiltration casting of a porous material preform by a molten component. In forging processes, a uniform mixture of, for example, powder particles of the metallic matrix and the reinforcement is cold-pressed into a green part which is subsequently hot forged at a suitably high temperature and under pressure to form a dense composite. Typically, the process is performed at a temperature below the solidus temperature of the metal matrix. Preferably, the forging operation is performed within a short or minimal exposure temperature to reduce the likelihood of any interfacial reactions between the ceramic particles and the metal matrix. Thus, in accordance with one or more embodiments of the invention, a Cu/SiC composite can be prepared by forging at about less than about 900° C. that has microstructural uniformity or homogeneity with little or no pores. In the liquid-state infiltration casting technique, also referred to as the liquid metal or pressure infiltration casting technique, a stable preform, such as a porous ceramic, is typically formed and machined as desired. Molten metal can be introduced into the preform under pressure. This facilitates liquid metal infiltration into the ceramic producing a pore-free component. For example, a SiC preform can be infiltrated with liquid copper to fabricate the components of the invention.

The porous ceramic preforms can be further rigidized or stiffened by sintering to create an interlocking network of ceramic particles that are strongly bonded together. Composite materials prepared by infiltration casting of such sintered preforms can be expected to have superior creep resistance, as typically compared to un-sintered preforms. The sintering time and temperature can depend on several factors including, but not limited to the type of ceramic, the size of the preform, and/or the extent of desired material reconfiguration. Sintering techniques can be performed on ceramic materials such as SiC at temperatures in the range of about 1700° C. to about 2300° C. Sintering can be performed at the sintering temperatures for any sufficient duration. For example, sintering can be performed for about one hour to about twelve hours.

The interconnect can have one or more coatings or layers on at least a portion of one or more surfaces thereof. Thus, for example, the interconnect of the invention can comprise a metal matrix composite having a coating on at least a portion of its surface. The coating can comprise any suitable material that can render it substantially nonporous or impermeable, electrically conductive, and, preferably, can provide oxidation or degradation protection. Preferably, the coating is impermeable to oxidizing agents and/or reducing agents at the operating or service temperature of the interconnect. The coating can be selected to provide an area specific resistance between the EEA and the coated interconnect of less than about 0.1 ohm-cm². Thus, for example, the coating can be one or more materials or compounds having a conductivity of at least about 1 S/cm; a CTE that is within about 80%, preferably within about 10%, more preferably within about 5%, of the CTE of the material of the interconnect; and/or a thermal conductivity of at least about 5 W/m·K, preferably at least about 10 W/m·K, more preferably at least about 100 W/m·K. Non-limiting examples of materials or compounds that can comprise the coating include, but are not limited to, conductive oxides, chromites, nickel oxide, doped or undoped lanthanum chromite, manganese chromite, yttria, lanthanum strontium manganite (LSM), lanthanum strontium chromite, noble metals such as platinum, gold, and silver, as well as nickel, and copper, doped or undoped electrically conductive perovskites, manganese chromite, and lanthanum strontium cobalt oxide, zirconium diboride, titanium silicon carbide, as well as mixtures or combinations thereof. Typically, the coating is applied to be as thin as possible while maintaining full density and provide the desired protective capacity and/or reduce any adverse or undesirable properties such as resistivity. For example, the coating can be less than about 50 μm thick, in some cases less than about 25 μm thick, in other cases less than about 10 μm thick, and in still other cases less than about 5 μm thick. Coating materials are commercially available from, for example, NexTech Materials, Ltd., Lewis Center, Ohio, Praxair Specialty Ceramics, Woodinville, Wash., and Trans-Tech, Inc., Adamstown, Md.

The coatings can be applied by any suitable technique including, but not limited to, vapor deposition, screen printing, fluidized bed immersion, plasma coating, spray coating, magnetron sputtering, and/or dip coating. For example, a coating can be deposited on an interconnect surface by plasma spraying, with an Ar flame, (La_{0.8}Sr_{0.2})_{0.9}MnO₃ powder with a particle size that is less than about 25 μm so as to obtain as thin a coating as possible while still providing the desired protective performance.

In accordance with further embodiments of the invention, a sublayer can be disposed between the coating and the surface of the interconnect material. The sublayer can be disposed on at least partially, preferably throughout, the interface between the coating and any contacted surface of the interconnect material. In some cases, the sublayer can serve as an additional barrier layer between the metal matrix composite material of the interconnect and the environment of the electrochemical cell. Preferably, the sublayer can isolate, or otherwise interfere with any unwanted or undesirable reactions between the interconnect material and the coating. The present invention also contemplates the use of one or more sublayers disposed on one or more portions or regions between the coating the interconnect material surface. Thus, one or more regions can have or not have any sublayer or one or more regions can have differing sublayer compositions. The sublayer can have any desired thickness that provides electrical conductivity and/or thermal conductivity. Typically, the sublayer is applied to be as thin as possible while maintaining full density and provide the desired protective capacity and/or reduce any adverse or undesirable properties such as resistivity. For example, the sublayer can be less than about 1 μm thick, in some cases less than about 0.5 μm thick, and in other cases less than about 0.1 μm thick. The sublayer can be applied by any suitable technique including, but not limited to, chemical or physical vapor deposition, fluidized bed immersion, and/or plasma coating. The sublayer can comprise, but is not limited to, titanium nitride, titanium aluminum nitride, titanium silicon carbide, or mixtures thereof.

The metal matrix composite can have one or more interfacial agents that can promote or serve to form a bridge between the discontinuous phase reinforcing component and the metal or metal alloy continuous phase. The interfacial agent can be deposited as an interfacial layer that facilitates adherence of a ceramic particle to the metal or metal alloy matrix. In some cases, the interfacial agent or layer can wet a surface of, for example, one or more fillers or additives incorporated into the metal or metal alloy matrix. The metal matrix composite can be prepared by exposing a ceramic filler to one or more species or reactants that can form a carbide, a nitride, an oxide, or combinations thereof. In some cases, the interfacial agent can comprise any reactive metal such as, but not limited to, titanium lanthanum, cerium, yttrium, silicon, vanadium, iron, and combinations thereof. The formed interfacial layer can forms a bond between a continuous phase, e.g. the metal or metal alloy matrix, and a discontinuous phase, e.g. the filler materials, to minimize any defects present or created at such interfaces. Typically, the reactive metal is selected to react or form an alloy with one or more components of the metal matrix composite and/or the coating. The amount of interfacial agent is typically as less as possible that still provides wetting, control of interfacial chemical behavior and optimization of composite properties, and can be less than about 5% by volume, less than about 2%, and in some cases less than about 1% of the metal matrix composite or relative to the metal of the metal matrix composite.

In accordance with one or more embodiments of the invention, the interconnect can consist essentially of or consist of copper or a copper alloy with a ceramic selected from the group consisting of silicon carbide, carbon, graphite, titanium boride, titanium carbide, boron carbide, aluminum oxide, or mixtures thereof.

In accordance with other embodiments of the invention, the electrochemical device can comprise an interconnect comprising a metal matrix composite. The metal matrix composite can consist essentially of a metal in a continuous phase and a ceramic in a discontinuous phase. The ceramic can consist essentially of a carbide, a diboride, an oxide, a dioxide, a silicate, and a nitride. For example, the ceramic can be one of carbon, boron carbide, silicon carbide, zirconium carbide, hafnium carbide, tantalum carbide, titanium carbide, zirconium diboride, hafnium diboride, tantalum diboride, titanium diboride, silicon dioxide, aluminum oxide, alumino-silicate, silicon nitride, and aluminum nitride.

However, in accordance with other embodiments of the invention, the interconnect can consist essentially of, or consist of, a non-intermetallic metal or metal alloy and a ceramic selected from the group consisting of silicon carbide, carbon, titanium boride, titanium carbide, boron carbide, aluminum oxide. The coating can consist essentially of or consist of a compound selected from the group consisting of doped or undoped electrically conductive perovskite, lanthanum chromite, manganese chromite, yttria, lanthanum strontium cobalt oxide, lanthanum strontium manganite, lanthanum strontium chromite, a noble metal nickel, and copper. The sublayer can consist essentially of or consist of a compound selected from the group consisting of titanium nitride, titanium aluminum nitride, titanium silicon carbide, or mixtures thereof.

Any EEA can be utilized in the invention. For example, the EEA can comprise an anode, an electrolyte, and a cathode. The anode can comprise any material that supports or promote fuel oxidation such as a cermet, having predominantly, continuous ceramic phase with a discontinuous metal phase such as Ni/YSZ (nickel/yttria stabilized zirconia), typically having a porosity of about 40%. The electrolyte can comprise an oxygen-conductive ceramic such as dense YSZ, typically having a porosity of less than about 1%. The cathode can comprise any material that catalyzes or promotes oxidant reduction such as lanthanum strontium manganite, typically having a porosity of about 40%. Electrodes-electrolyte assemblies are commercially available from for example, Innovative Dutch Electro Ceramics (InDEC B.V.), the Netherlands and NexTech Materials, Ltd., Lewis Center, Ohio.

The invention can further utilize one or more bonding agents securing or at least facilitating electrical and/or thermal communication, and/or structural support between components of the stack. For example, a bonding agent can be disposed at the EEA/interconnect interface 22 to reduce the likelihood of separation. Examples of bonding agents include, but are not limited to, Ag/CuO/TiO₂, Ag/CuO, Ag/TeO₃, Pt/Nb₂O₅, Pt (paste), and Ag (paste). The selection of the type of bonding agent can depend on several factors such as chemical or thermo-mechanical stability with respect to other component materials, desired mechanical and thermal properties.

In accordance with one or more embodiments, the invention relates to a method of facilitating electrical power generation. The method can comprise an act of providing a fuel cell comprising an EEA and an interconnect disposed in contact with a surface of the EEA, the interconnect comprising a metal matrix composite of a copper or copper alloy and a ceramic selected from the group consisting of silicon carbide, boron carbide, and aluminum oxide.

### EXAMPLES

The function and advantages of these and other embodiments of the invention can be further understood from the examples below. The examples illustrate the benefits and/or advantages of the articles, components, systems, and techniques of the invention but do not exemplify the full scope of the invention.

### Example 1

Fabrication of Cu/SiC Materials by Solid State Powder Forging.

Metal matrix composites of Cu/SiC specimens were prepared by solid state powder forging with a target CTE of about 12.1×10⁻⁶/° C., at a temperature range of 20-800° C. Based on FIG. 2A, target composition ranges of the Cu/SiC were delineated to be in a range of about 40% to about 60% by volume copper and in a range of about 40 to about 60% by volume silicon carbide. Thus, specimens having about 40%, about 47.5%, and about 55% by volume (about 19.3 wt %, about 24.5 wt %, and about 30.5 wt %, respectively) silicon carbide, with corresponding amounts of copper (about 60 vol %, about 52.5 vol %, and about 45 vol %, respectively), were prepared. Further, silicon carbide particle sizes of about 10 μm to about 20 μm, about 40 μm to about 60 μm, and about 100 μm were utilized for each of the three silicon carbide content levels. Copper with particle size of about 10 to about 15 μm were utilized for the 15 μm (10-20 μm) SiC specimens; copper with particle size of about 30-35 μm were utilized for the 50 μm (40-60 μm) SiC specimens; and copper with particle size of about 75 to about 100 μm were utilized for the 100 μm SiC specimens.

The SiC particles were coated with a thin layer of copper via a vapor phase process. The coated SiC particles were then blended with copper particles to achieve a uniform dispersion, cold-pressed into plates, and then forged at a temperature of less than about 900° C. for a period of less than about one minute.

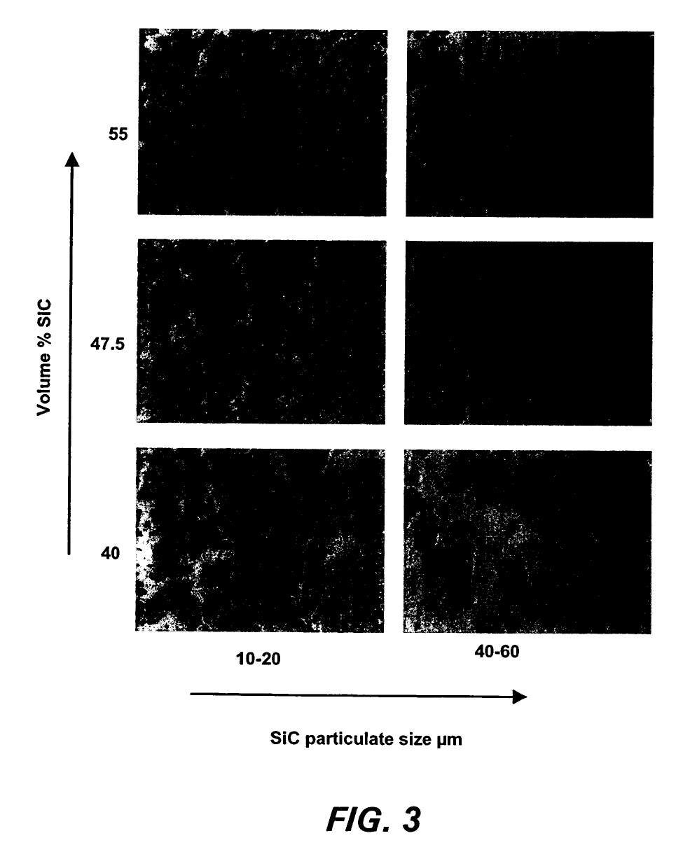

FIG. 3 are copies of micrographs of portions of some of the prepared specimens; the micrographs show that Cu/SiC composite materials can be prepared by forging to have a continuous phase (lighter regions) reinforced with a discontinuous phase (darker regions).

### Example 2

Fabrication of Cu/SiC, Cu/B₄C, Cu/Al₂O₃, Materials by Infiltration Casting.

Metal matrix composites specimens of Cu/SiC, Cu/B₄C, and Cu/Al₂O₃ were prepared by infiltration casting. Each of the specimens had about 55% by volume reinforcing material, SiC, B₄C, or Al₂O₃. Porous preforms were prepared by slurry casting or injection molding techniques. Infiltration casting of the preforms was performed with molten copper under an inert atmosphere (argon).

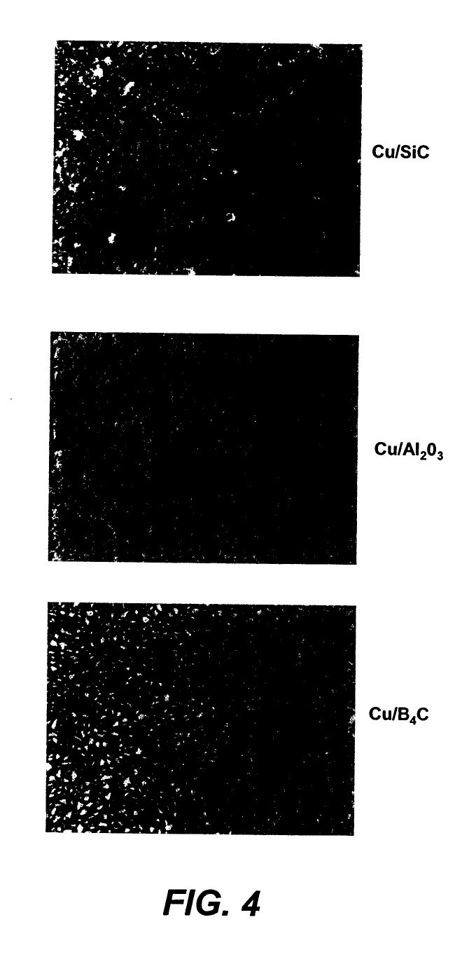

FIG. 4 are copies of micrographs of the prepared specimens; the micrographs show that Cu/SiC, Cu/B₄C, Cu/Al₂O₃ composites can be prepared by casting to have homogeneous distribution of the reinforcing materials in the continuous metal phase (lighter region).

### Example 3

Analysis of Cu/SiC, Cu/B₄C, Cu/Al₂O₃ Materials.

CTE measurements (ASTM E228) were performed for each of the infiltration cast specimens prepared as substantially described in Example 2. The CTE measurements were performed by heating from about 20° C. to about 800° C. and cooling to about 20° C. The measured heating cycle CTE and the measured cooling cycle CTE are shown on FIGS. 2A-2C for each of the Cu/SiC, Cu/B₄C, and Cu/Al₂O₃ specimens.

The results presented in FIGS. 2A-2C show that the measured CTE closely correlated to the rule of mixtures model (measured CTE during heating “▴” and cooling “●”). Notably, the measured CTE values were within about 2.5% of the target CTE (12.1×10⁻⁶/° C.).

Some of the formed Cu/SiC specimens showed an interfacial layer which was not observed in the Cu/Al₂O₃ specimens. Thermal aging tests were also performed by heat soaking the Cu/SiC, Cu/B₄C, and Cu/Al₂O₃ specimens at a temperature of about 800° C. for about 100 hours in an inert atmosphere. SEM examination of the soaked specimens did not reveal any degradation at the metal-ceramic interface.

### Example 4

Influence of Particle Size.

Forged Cu/SiC composite specimens (47.5% by volume SiC) were prepared utilizing SiC having particle sizes of about 15 μm and about 50 μm by forging techniques as substantially described in Example 1.

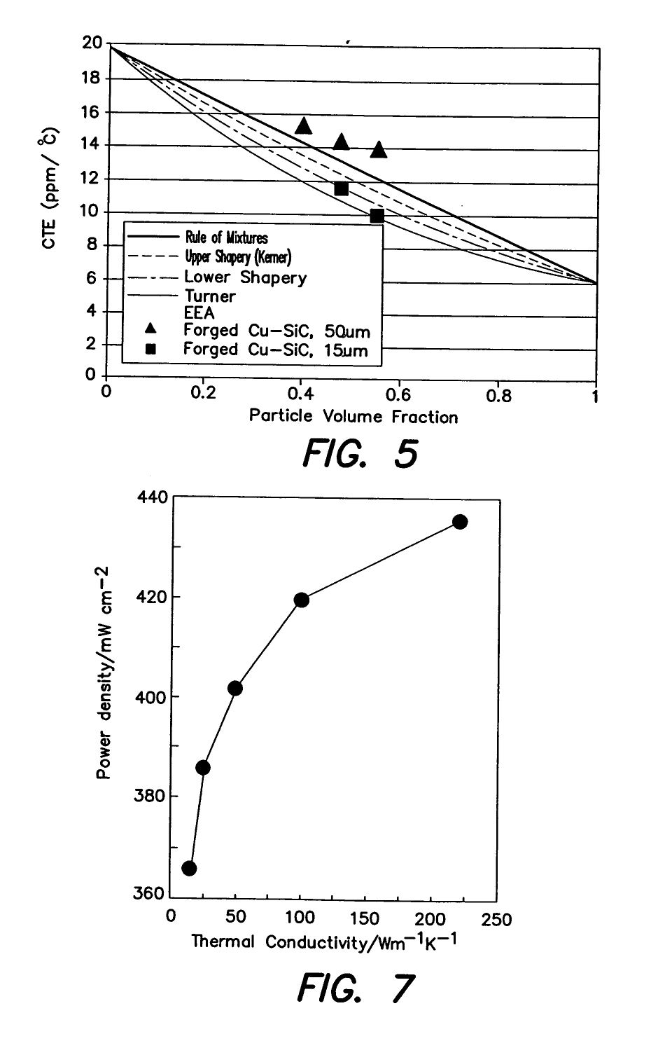

The CTE of the specimens were measured and presented (as tangent CTE between about 20° C. and about 800° C.) in FIG. 5. The results show a close match to a target CTE of an EEA (about 12.1×10⁻⁶/° C.) but the specimen utilizing smaller particle size reinforcing materials appears to yield a closer correlation compared to the specimen utilizing larger particle size reinforcing materials.

### Example 5

Predicted SOFC Performance.

The advantages of an interconnect comprising materials having a high thermal conductivity, at least about 100 W/m·K, can result in components of an electrochemical device having a more uniform temperature distribution, which in turn can improve the stack power density and reduce the associated thermo-mechanical stresses in the electrodes electrolyte assembly. Use of interconnect materials having a high thermal conductivity can provide SOFC power systems with higher energy conversion efficiency and lower costs compared to similar systems that rely on interconnect materials with a lower thermal conductivity. Further, materials having higher thermal conductivity can reduce the air flow required to cool the stack and consequently reduce the parasitic(power losses associated therewith. Higher stack power density can reduce costs associated with stack materials because the amount of stack materials required is typically approximately inversely proportional to the stack power density.

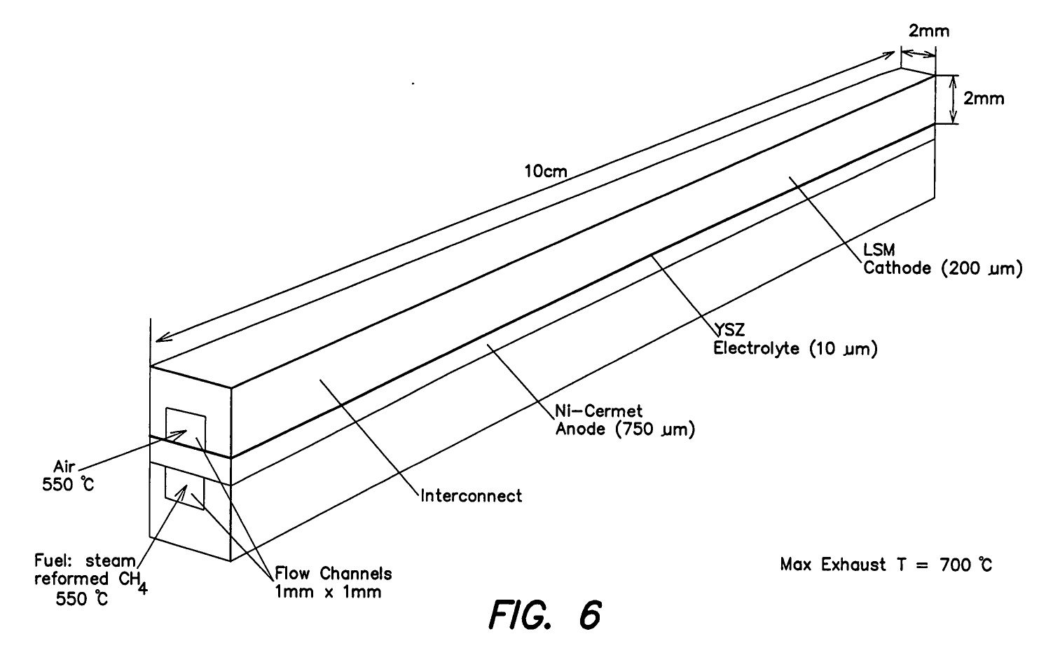

To analyze the influence of thermal conductivity on stack power density, numerical simulations were performed. Specifically, the performance of anode supported SOFCs, schematically shown in FIG. 6, were simulated. (FIG. 6 also shows the geometry of the simulated SOFC, the co-flow configuration of the reactant gases.) The simulation models utilized software that was developed using finite element analysis principles. The simulation model is described in a report submitted to the U.S. Department of Energy, NETL, on October 2002, entitled “Structural Limitations in the Scale-up of Anode Supported SOFCs.” The model was developed to predict the spatial distribution of temperature, current density, species concentration, thermo-mechanical stresses of an operating SOFC.

The SOFC was modeled to operate at 0.7 V, utilizing about 85% of reformed natural gas fuel, with the inlet gas temperature at 550° C. and exhaust gases at about 700° C. and a contact resistance at the interconnect/EEA interface of about 0.1 ohm-cm², the air flow rate was estimated to be 700% more than that required for the electrochemical reaction in order to keep the exhaust gas temperatures at approximately 700° C.

The inlet and exit gas temperatures were found to be consistent with system level energy balance considerations. The results presented in FIG. 7 shows the associated predicted power density. The model results predict that increasing the thermal conductivity of the interconnect material reduces the temperature gradients across the cell, which in turn results in a higher power densities because higher effective cell temperatures are realized to improve conversion kinetics and reduce resistance losses.

Thus, utilizing metal matrix components of the invention, having high thermal conductivity, can lead to in increased power generation. Further, the modeling results validate that the use of highly thermally conductive interconnect materials in SOFC applications improves overall system efficiency because parasitic losses associated with cooling air flow requirements are reduced in systems with higher power density.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention.

Although the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. It is to be appreciated that various alterations, modifications, and improvements can readily occur to those skilled in the art and that such alterations, modifications, and improvements are intended to be part of the disclosure and within the spirit and scope of the invention. For example, the use of other models to predict an CTE and/or to provide a composition to achieve a target CTE can be utilized in the invention. Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Further, as used herein, “plurality” means two or more. Where used herein, a “set” of items may include one or more of such items.

Those skilled in the art should appreciate that the parameters and configurations described herein are exemplary and that actual parameters and/or configurations will depend on the specific application in which the systems and techniques of the invention are used. Those skilled in the art should recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

1. A electrochemical device comprising:
an electrodes-electrolyte assembly; and
an interconnect in communication with the electrodes-electrolyte assembly, the interconnect comprising a metal matrix composite of at least one metal selected from the group consisting of copper, oxide dispersion strengthened copper, aluminum, titanium, and alloys thereof, and at least one reinforcing material selected from the group consisting of carbon, boron carbide, silicon carbide, zirconium carbide, hafnium carbide, tantalum carbide, titanium carbide, zirconium diboride, hafnium diboride, tantalum diboride, titanium diboride, silicon dioxide, aluminum oxide, alumino-silicate, silicon nitride, aluminum nitride, and mixtures thereof.

2. The electrochemical device of claim 1, further comprising a coating on a surface of the interconnect.

3. The electrochemical device of claim 2, wherein the coating comprises a nonporous, electrically conductive material.

4. The electrochemical device of claim 2, wherein the coating comprises at least one material selected from the group consisting of lanthanum strontium manganite, lanthanum strontium chromite, a noble metal, nickel, and copper.

5. The electrochemical device of claim 4, further comprising a sublayer disposed between the coating and the surface of the interconnect.

6. The electrochemical device of claim 5, wherein the sublayer comprises an electrically conductive material selected from the group consisting of titanium nitride, titanium aluminum nitride, or mixtures thereof.

7. The electrochemical device of claim 1, wherein the interconnect has a coefficient of thermal expansion that is within 20% of a coefficient of thermal expansion of the electrodes-electrolyte assembly.

8. The electrochemical device of claim 7, wherein the interconnect has a coefficient of thermal expansion that is within about 10% of a coefficient of thermal expansion of the electrodes-electrolyte assembly.

9. The electrochemical device of claim 8, wherein the interconnect has a coefficient of thermal expansion that is within about 5% of a coefficient of thermal expansion of the electrodes-electrolyte assembly.

10. The electrochemical device of claim 9, wherein the interconnect has a coefficient of thermal expansion that is within about 2.5% of a coefficient of thermal expansion of the electrodes-electrolyte assembly.

11. The electrochemical device of claim 1, further comprising an interfacial agent disposed between the metal and the reinforcing material.

12. The electrochemical device of claim 11, wherein the interfacial agent comprises a reactive metal selected from the group consisting of titanium lanthanum, cerium, yttrium, silicon, vanadium, iron, and combinations thereof.

13. The electrochemical device of claim 1, wherein the interconnect has a thermal conductivity of at least about 50 W/m·K.

14. The electrochemical device of claim 13, wherein the interconnect has a thermal conductivity of at least about 100 W/m·K.

15. The electrochemical device of claim 14, wherein the interconnect has a thermal conductivity of at least about 150 W/m·K.

16. The electrochemical device of claim 15, wherein the interconnect has a thermal conductivity of at least about 220 W/m·K

17. The electrochemical device of claim 1, wherein the electrochemical device is a solid oxide fuel cell.

18. An electrochemical device comprising a metal matrix composite and an electrodes-electrolyte assembly in communication with the metal matrix composite, the metal matrix composite having a coefficient of thermal expansion of about 6×10⁻⁶ to about 14×10⁻⁶/° C. and within about 10% of a coefficient of thermal expansion of the electrodes-electrolyte assembly.

19. The interconnect of claim 18, wherein the metal matrix composite has a coefficient of thermal expansion of about 10×10⁻⁶ to about 13×10⁻⁶/° C.

20. The interconnect of claim 19, wherein the metal matrix composite has a coefficient of thermal expansion of about 11.5×10⁻⁶ to about 12.5×10⁻⁶/° C.

21. The interconnect of claim 18, wherein the metal matrix composite comprises from about 20% to about 80% by volume copper or a copper alloy and from about 20% to about 80% by volume silicon carbide.

22. The interconnect of claim 21, wherein the metal matrix composite comprises from about 40% to about 60% by volume copper and from about 40% to about 60% by volume silicon carbide.

23. The interconnect of claim 22, wherein the metal matrix composite comprises about 45% by volume copper and about 55% by volume silicon carbide.

24. The interconnect of claim 18, wherein the metal matrix composite comprises from about 20% to about 80% by volume of copper or copper alloy and from about 20% to about 80% by volume boron carbide.

25. The interconnect of claim 24, wherein the metal matrix composite comprises about 45% by volume copper and about 55% by volume boron carbide.

26. The interconnect of claim 18, wherein the metal matrix composite comprises from about 20% to about 80% by volume copper or copper alloy and from about 20% to about 80% by volume aluminum oxide.

27. The interconnect of claim 18, further comprising an interfacial agent disposed between the metal and the reinforcing material.

28. The interconnect of claim 27, wherein the interfacial agent comprises a reactive metal selected from the group consisting of titanium, lanthanum, cerium, yttrium, silicon, vanadium, iron, and combinations thereof.

29. A method of generating electrical energy comprising providing fuel and oxidizer to a fuel cell comprising a metal matrix composite of at least one metal selected from the group consisting of copper, oxide dispersion strengthened copper, aluminum, titanium, and alloys thereof, and at least one reinforcing material selected from the group consisting of carbon, boron carbide, silicon carbide, zirconium carbide, hafnium carbide, tantalum carbide, titanium carbide, zirconium diboride, hafnium diboride, tantalum diboride, titanium diboride, silicon dioxide, aluminum oxide, alumino-silicate, silicon nitride, aluminum nitride, and mixtures thereof.

30. A method of facilitating electrical power generation comprising providing a fuel cell comprising an electrodes-electrolyte assembly and an interconnect disposed in contact with a surface of the electrodes-electrolyte assembly, the interconnect comprising a metal matrix composite of a copper or copper alloy and a ceramic selected from the group consisting of silicon carbide, boron carbide, and aluminum oxide.

31. A method of fabricating a fuel cell comprising:
providing an electrodes-electrolyte assembly; and
providing an interconnect comprising a metal matrix composite having a coefficient of thermal expansion that is within about 10% of a coefficient of thermal expansion of the electrodes-electrolyte assembly.
